(19) United States
(12) Patent Application Publication
(10) Pub. No.: US 2005/0133316 A1
(43) Pub. Date: Jun. 23, 2005

(54) Low coast brake of an automatic transmission

(76) Inventor: Kyu Chul Hwang, Seoul (KR)

Correspondence Address: MORGAN, LEWIS & BOCKIUS LLP (SF), 2 PALO ALTO SQUARE, PALO ALTO, CA, 94306, US

(21) Appl. No.: 11/016,207

(22) Filed: Dec. 17, 2004

(30) Foreign Application Priority Data
Dec. 19, 2003 (KR) 10-2003-0093927

(51) Int. Cl. F16D 55/36

(52) U.S. Cl. 188/71.5

(57) ABSTRACT

A low coast brake includes a plurality of main plates having, respectively, a body part, a tooth part formed on an outer circumference of the body part, and having a plurality of teeth formed with a gap of a first predetermined angle thereon, and a non-tooth part formed with a gap of a second predetermined angle on an outer circumference of the body part, having no teeth in order to enhance a fluidity of a hydraulic fluid. Such and arrangement decreases cost and weight and increases fuel mileage and improves shift feel.

### CROSS-REFERENCE TO RELATED APPLICATIONS

This application claims priority of Korean Application No. 10-2003-0093927, filed Dec. 19, 2003, the disclosure of which is incorporated herein by reference.

### FIELD OF THE INVENTION

Generally, the present invention relates to an automatic transmission. More particularly, the present invention relates to a low coast brake for an automatic transmission.

### BACKGROUND OF THE INVENTION

Generally, a low coast brake of an automatic transmission is to operate when a current shift speed is shifted into a first speed or a second speed under an engine brake ON condition. The low coast brake is connected on an inner race of a forward one way clutch (FWD O.W.C), such that the low coast brake is operated with a forward brake when the forward brake is operated.

The low coast brake typically includes a piston, a plurality of main plates, a plurality of friction plates being alternately disposed to the main plates, and a reaction plate. Accordingly, the low coast brake engages/disengages an operational element by sliding up to the left/right according to a provided hydraulic fluid.

However, since there is a shortage of flow space of the hydraulic fluid in the conventional low coast brake, the low coast brake can have a problem in that operation can be retarded. Consequently, since disengagement of the operational element is retarded, the low coast brake creates a problem that fuel is unnecessarily wasted

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide a low coast brake for an automatic transmission having non-limiting advantages including enhanced fuel mileage.

An exemplary low coast brake according to an embodiment of the present invention includes: a plurality of main plates; a plurality of friction plates, the main plates and the friction plates being alternately disposed; a piston configured to operate by a hydraulic fluid and selectively pressing the plurality of main and friction plates to generate a friction force therebetween; and a reaction plate providing a reaction force to the main and friction plates. Each of the plurality of main-plates may comprise a body part; a tooth part formed on an outer circumference of the body part, and having a plurality of teeth formed one by one with a gap of a first predetermined angle; and a non-tooth part formed one-by-one with a gap of a second predetermined angle on an outer circumference of the body part, having no teeth in order to enhance a fluidity of a hydraulic fluid.

In another embodiment according to the present invention, the plurality of main plates may comprise a pair of side main plates and a center main plate disposed between the side plates, wherein a diameter of the body part of the center plate is different from a diameter of the body part of the side plates.

In a further embodiment according to the present invention, the diameter of the body part of the center main plate is smaller than the diameter of the body part of the side main plates.

In a further embodiment according to the present invention, the center main plate has a thickness smaller than the side main plates.

In a still further embodiment according to the present invention, a groove is formed on each tooth of the main plates.

In a further embodiment according to the present invention, the reaction plate comprises: a body part; and a tooth part formed on an outer circumference of the body part, having a plurality of teeth formed one by one with a gap of the first predetermined angle.

In further embodiment according to the present invention, a groove is formed on each tooth of the reaction plate.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of a low coast brake of an automatic transmission according to an embodiment of the present invention;

FIG. 2 is a vertical sectional view of a piston, in a low coast brake of an automatic transmission according to an embodiment of the present invention;

FIG. 3 is a front view of a main plate, in a low coast brake of an automatic transmission according to an embodiment of the present invention;

FIG. 4 is a front view of a reaction plate, in a low coast brake of an automatic transmission according to an embodiment of the present invention; and

FIG. 5 is a graph showing relation between input revolutions rpm and friction (Nm), in order to compare a friction value between a low coast brake according to an embodiment of the present invention and a conventional low coast brake.

### DETAILED DESCRIPTION OF THE PREFERRED EMBODIMENTS

An embodiment of the present invention will hereinafter be described in detail with reference to the accompanying drawings.

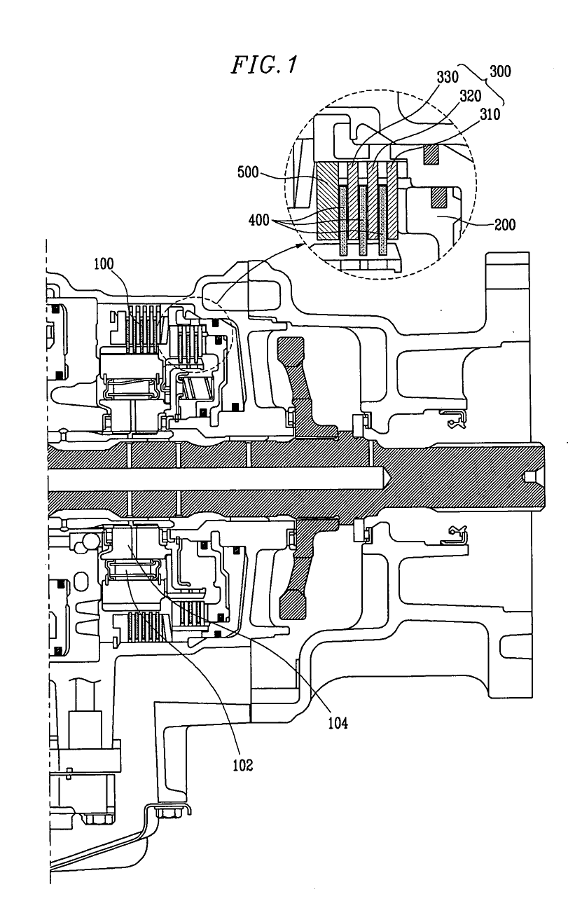

As shown in FIG. 1, a low coast brake of an automatic transmission according to an embodiment of the present invention is connected on an inner race 104 of a forward one way clutch (FWD O.W.C) 102, such that the low coast brake is operated with a forward brake 100 when the forward brake is operated. In addition, a low coast brake of an automatic transmission according to an embodiment of the present invention includes a piston 200, a plurality of main plates 300, a plurality of friction plates 400, and a reaction plate 500.

The plurality of main plates 300 and the plurality of friction plates 400 are alternately disposed. The piston 200 selectively presses on the plurality of main and friction plates 300 and 400 to generate a friction force therebetween. The reaction plate 500 provides a reaction force to the main and friction plates 300 and 400.

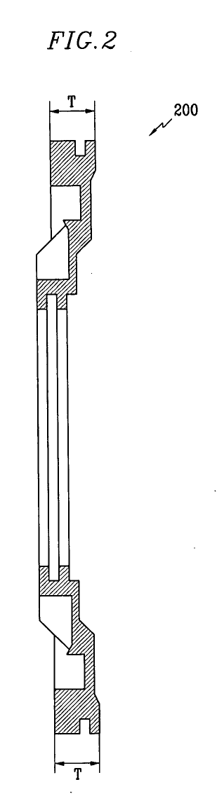

As shown in FIG. 2, the piston 200 is designed at thickness T, which is typically smaller than a conventional piston, in order to enhance a fluidity of a hydraulic fluid. In an exemplary embodiment of the present invention, by way of comparison, if the thickness of a conventional piston may be about 9.3 to 10.9±0.1 mm, the thickness T of a corresponding piston of an embodiment of the present invention becomes about 8.6 to 10.2±0.05 mm. The specific thickness can be determined through experiments, and these are minimum values in which the fluidity of the hydraulic fluid is enhanced while a performance of the main plate is maintained to be substantially equal to that of the conventional brake.

As has been explained, since the specific thickness T of the piston 200 is decreased in comparison with the thickness of a conventional piston, the flow-space of the hydraulic fluid can be further increased in proportion to the decreased thickness. Accordingly, since the fluidity of the hydraulic fluid is enhanced, the low coast brake of an automatic transmission according to an embodiment of the present invention can reduce a drag phenomenon.

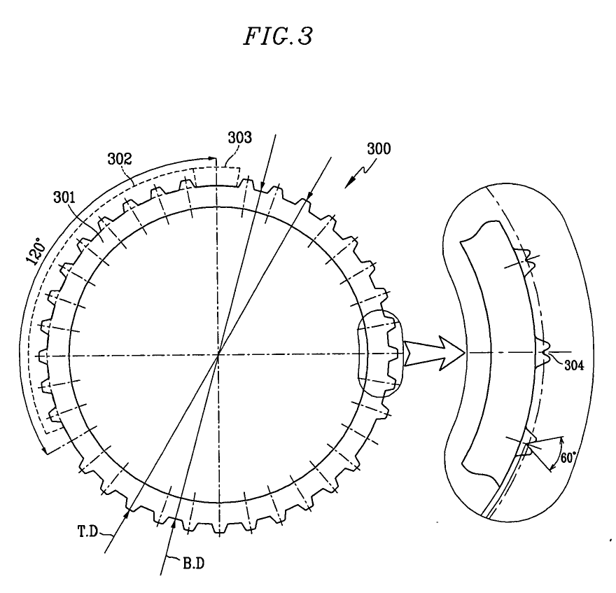

As shown in FIG. 3, the main plate 300 includes a body part 301 with a wheel shape, a tooth part 302 formed on a portion of an outer circumference of the body part 301, and a non-tooth part 303 formed on another portion of the outer circumference of the body part 301. The tooth part 302 has a plurality of teeth. In a preferred embodiment, the teeth are formed with a gap of a first predetermined angle (e.g., 10°) along a circumference direction. The non-tooth part 303 has no teeth in order to enhance the fluidity of the hydraulic fluid, and is formed with a gap of a second predetermined angle (e.g., 120°) along a circumference direction on the outer circumference of the body 301.

Furthermore, as shown in FIG. 1, the main plate 300 includes a first and a second side main plate 310 and 330, a center main plate 320 disposed between the first and the second side main plates 310 and 330. The first side main plate 310, the center main plate 320, and the second side main plate 330 have, respectively, the above-explained body part 301, tooth part 302, and non-tooth part 303.

In addition, the first side main plate 310, the center main plate 320, and the second side plate 330 have, respectively, a groove 304 formed on each tooth thereof, in order to enhance the fluidity of the hydraulic fluid. The groove 304 may have a concave shape, and an inner-angle thereof is about 60°. Also, the first and the second side main plates 310 and 330 have a same thickness and same body-diameter (B.D) as each other. In contrast, the center main plate 320 disposed between the first and the second side main plates 310 and 330 has a different thickness and body-diameter (B.D) to the first and the second side main plates 310 and 330. The center main plate 320 is designed at a smaller thickness and body-diameter (B.D) than the first and the second side main plate 310 and 330, in order to further enhance the fluidity of the hydraulic fluid.

Since the body-diameter (B.D) becomes relatively small in a state that the tooth-diameter (T.D) is not varied, the flow-space for hydraulic fluid between neighboring teeth can be further enlarged. Particularly, since the center main plate 320, having such an enlarged flow-space, is disposed between the first and the second side main plates 310 and 330, the hydraulic fluid moving from the first side main plate 310 (or from the second side main plate 330) to the second side main plate 330 (or to the first side main plate 310) can move more quickly.

In an exemplary embodiment of the present invention, if the body-diameter B.D and the thickness of the first and the second side main plates 310 and 330 may be, respectively, 141.4±0.15 mm and 2.0 mm (equal to a body-diameter and a thickness of the conventional main plate), the body-diameter B.D and a thickness of the center main plate becomes, respectively, about 138.4±0.15 mm and about 1.8 mm. These specific body-diameter B.D and thickness values can be determined through experiments, and these are minimum values in which the fluidity of the hydraulic fluid is enhanced while a performance of the main plate is maintained to be substantially equal to that of the conventional brake.

Accordingly, the low coast brake according to an embodiment of the present invention can be enhanced in the fluidity of the hydraulic fluid by the non-tooth part 303, the groove 304, the specific body-diameter B.D, and the specific thickness.

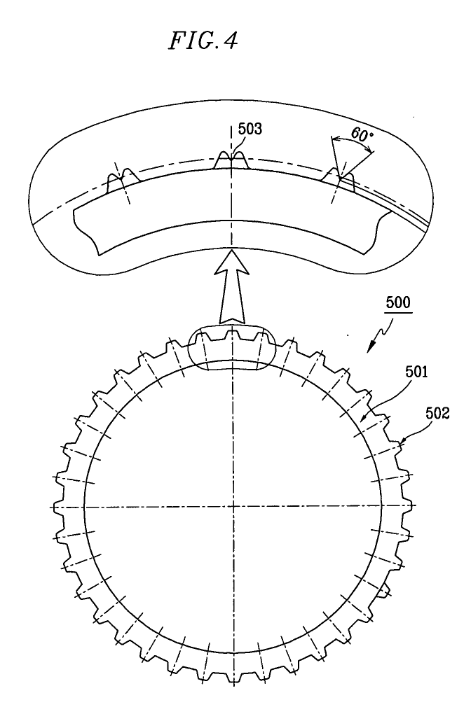

As shown in FIG. 4, the reaction plate 500 includes a body part 501 with a wheel shape, and a tooth part 502 formed on an outer circumference of the body part 501. The tooth part 502 has a plurality of teeth. Particularly, the teeth are formed with a gap of a first predetermined angle (e.g., 10°) along a circumference direction. In addition, the reaction plate 500 has a groove 503 formed on each tooth thereof, in order to enhance the fluidity of the hydraulic fluid. Particularly, the groove 503 has a concave shape, and an inner-angle thereof is about 60°. Accordingly, the reaction plate 500 can be enhanced in the fluidity of the hydraulic fluid by the groove 503.

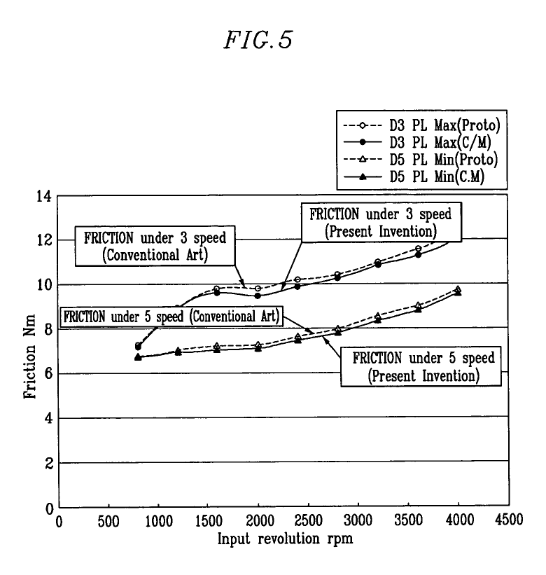

As shown in FIG. 5, a low coast brake of an automatic transmission according to an embodiment of the present invention can further decrease in the friction value by 5% in comparison with the conventional low coast brake. This plot is to be determined through experiment in which all the above-explained parameters (the non-tooth part 303, the groove 304, the specific thickness T, and the specific body-diameter B.D) are applied.

As has been explained, the low coast brake of an automatic transmission according to embodiments of the present invention has a number of advantages. For example, since a low coast brake has a non-tooth part, a groove, a predetermined thickness, and a predetermined external-diameter, a fluidity of a hydraulic fluid can be enhanced. Consequently, since an operational element is quickly disengaged by the hydraulic fluid, fuel mileage can be enhanced. In addition, shift feel can be enhanced during a shift. In addition, according to embodiments of the present invention, since a low coast brake has a non-tooth part, a groove, a predetermined thickness, and a predetermined external-diameter, weight and cost can be decreased.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A low coast brake of an automatic transmission, comprising:
a plurality of main plates;
a plurality of friction plates, the main plates and the friction plates being alternately disposed;
a piston configured to operate by a hydraulic fluid and selectively pressing the plurality of main and friction plates to generate a friction force therebetween; and
a reaction plate providing a reaction force to the main and friction plates,
wherein each of the plurality of the main-plates comprises
a body part,
a tooth part formed on an outer circumference of the body part, and having a plurality of teeth formed with a gap of a first predetermined angle, and
a non-tooth part formed with a gap of a second predetermined angle on an outer circumference of the body part, having no teeth in order to enhance a fluidity of a hydraulic fluid.

2. The low coast brake of claim 1, wherein the plurality of main plates comprises:
a pair of side main plates; and
a center main plate disposed between the side plates,
wherein a diameter of the body part of the center plate is different from a diameter of the body part of the side plate.

3. The low coast brake of claim 2, wherein the diameter of the body part of the center main plate is smaller than the diameter of the body part of the side main plates.

4. The low coast brake of claim 2, wherein the center main plate has a thickness smaller than the side main plates.

5. The low coast brake of claim 1, wherein a groove is formed on each tooth of the main plates.

6. The low coast brake of claim 1, wherein the reaction plate comprises:
a body part; and
a tooth part formed on an outer circumference of the body part, having a plurality of teeth formed with a gap of the first predetermined angle.

7. The low coast brake of claim 6, wherein a groove is formed on each tooth of the reaction plate.
